(19) United States
(12) Patent Application Publication
(10) Pub. No.: US 2008/0229502 A1
(43) Pub. Date: Sep. 25, 2008

(54) AUTOMATED BEDPAN SYSTEM AND METHOD THEREFOR

(76) Inventor: William Johnson, Opelika, AL (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 12/053,033

(22) Filed: Mar. 21, 2008

Related U.S. Application Data
(60) Provisional application No. 60/919,239, filed on Mar. 21, 2007.

(51) Int. Cl. A61G 7/02

(52) U.S. Cl. 5/604

(57) ABSTRACT

An automated bedpan system for selectively moving a bedpan between a first storage position, such as beneath a bed, and a second use position, such as proximate an opening in the bed, such that an individual in the bed may use the bedpan with or without assistance, in a safe, convenient, and comfortable manner, with reduced risk of spillage of waste material, and such that after use the bedpan may be stored without spillage of waste material and without leakage of odor from the bedpan.

### RELATED APPLICATION

The present non-provisional United States patent application is related to, and hereby claims priority to and the full benefit of, United States provisional application entitled “Automated Bedpan System” filed 21 Mar. 2008 on behalf of William Johnson, having assigned Ser. No. 60/919,239.

### TECHNICAL FIELD

The present disclosure relates generally to patient care, and, more specifically, to a bed having an automated bedpan.

### BACKGROUND OF THE INVENTION

For any number of reasons, a patient, or any other individual, may be confined to a bed for some time. When so confined, it may be very difficult, or even impossible for the patient to move, with or without assistance, to a toilet facility in order to relieve himself. As a rudimentary solution to this problem, bedpans have been employed, which allow the patient to relieve himself without getting out of bed, and without moving to a toilet facility.

Unfortunately, however, conventional use of bedpans is often uncomfortable for the patient due to the awkward placement of the pan between a mattress and the patient. Furthermore, such placement of the bedpan often results in spillage of biological waste material, creating an unsanitary condition which must be corrected by changing the bed sheets. The process of changing and cleaning the bed sheets is costly, both in time and resources, and additionally may be painful or inconvenient for the patient. Finally, conventional use of a bedpan requires the immediate assistance of a nurse or other aide in placing the bedpan beneath the patient at the appropriate time, i.e. when the patient needs to use the bedpan, which makes the patient dependent on the nurse, interrupts the nurse's other work or duties, invades the patient's privacy, and often is a source of embarrassment for the patient.

Thus, what is clearly needed is a system that allows a patient or other individual who is confined to a bed, or otherwise unable to conveniently move to a toilet facility in order to use same, to relieve himself in a safe, sanitary, and convenient manner without the immediate assistance of a care-taker.

### BRIEF SUMMARY OF THE INVENTION

Briefly described, in a preferred embodiment, the system of the present disclosure overcomes the above-mentioned disadvantages and meets the recognized need for such a system by providing a bed and a bedpan connected thereto via carriage means.

According to its major aspects and broadly stated, the system, in its preferred form, is an automated bedpan system comprising a bed having a first bed portion and a second bed portion, and a bedpan removably connected to carriage means for moving the bedpan between a first storage position and a second use position, wherein the carriage means is operable with the bed to move the bedpan into a gap between the first and second bed portions.

Specifically, the first bed portion is preferably movably connected to the second bed portion such that when the first portion and the second portion are moved away from one another, a gap is formed between the first bed portion and the second bed portion proximate the bedpan. The carriage means is preferably configured to move the bedpan into the second position, proximate the gap, from below the first and second bed portions when the first bed portion and the second bed portion are separated. Furthermore, the carriage means preferably includes a motor and is preferably further configured to selectively move the first and second bed portions away from one another upon activation thereof by a user. The bedpan preferably includes a cover for sealing biological waste contents therein; thereby, preventing spillage and preventing or reducing unwanted odors from escaping the bedpan.

Accordingly, a feature and advantage of the system of the present disclosure is its ability to allow a patient or other individual who is confined to a bed, or otherwise unable or unwilling to move to a toilet facility, to move a bedpan from a first storage position to a second use position for use thereof, and to return the bedpan to the first storage position when the bedpan is no longer needed, all without assistance.

Another feature and advantage of the system of the present disclosure is its ability to seal the bedpan and to store the bedpan away from a user whereby contact with biological waste material contained therein is prevented, and whereby spillage and/or the escape of unwanted odor is prevented.

Yet another feature and advantage of the system of the present disclosure is ability to store the bedpan in a location that is easily accessible to a nurse, care-taker, or other assistant for emptying and/or cleaning thereof.

Another feature and advantage of the system of the present disclosure is its ability to retain the bedpan in a comfortable and convenient position during use such that user discomfort and spillage of waste material are reduced.

Another feature and advantage of the system of the present disclosure is its ability to maintain a user's privacy when using the bedpan, thereby avoiding embarrassment associated with use of conventional bedpans.

These and other objects, features, and advantages of the invention will become apparent to those ordinarily skilled in the art after reading the following Detailed Description of the Invention and Claims in light of the accompanying drawing Figures.

### BRIEF DESCRIPTION OF THE DRAWINGS

Accordingly, the system of the present disclosure will be understood best through consideration of, and reference to, the following Figures, viewed in conjunction with the Detailed Description of the Invention referring thereto, in which like reference numbers throughout the various Figures designate like structure and in which:

FIG. 1 is a side view of an automated bedpan system in a first storage configuration;

FIG. 2 is a side view of the automated bedpan system of FIG. 1 in a second use configuration;

FIG. 3 is a top view of the automated bedpan system of FIG. 1;

FIG. 4 is a top view of an automated bedpan system according to an alternate embodiment;

FIG. 5 is a side view of the automated bedpan system of FIG. 4; and

FIG. 6 is a side view of an automated bedpan system according to another alternate embodiment.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the system of the present disclosure, specific terminology is employed for the sake of clarity. The invention, however, is not intended to be limited to the specific terminology so selected, and it is to be understood that each specific element includes all technical equivalents that operate in a similar manner to accomplish a similar purpose.

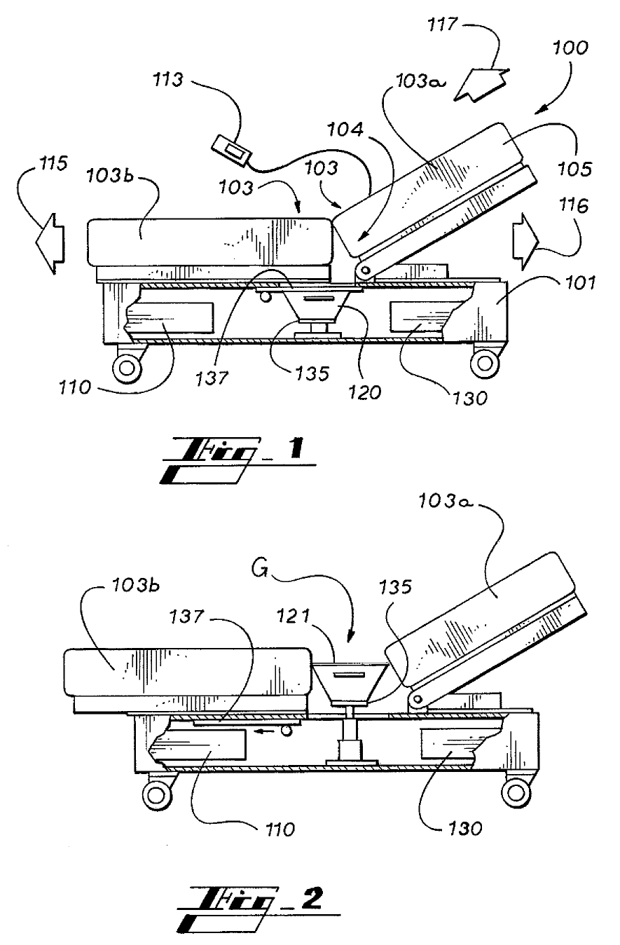

In the embodiment chosen for purposes of illustration in FIGS. 1-3, the automated bedpan system includes hospital bed 100, which preferably includes frame 101 for supporting mattress 103 on which a patient may rest. Preferably, frame 101 is configurable in a plurality of different configurations to adjust the relative positions of at least head section 103a and foot section 103b of mattress 103 according to the needs of the patient using hospital bed 100. Adjustment of the configuration of hospital bed 100 is preferably accomplished via drive means 110 which may be selectively controlled by the patient or an assistant via remote control device 113 or by controls disposed on frame 101.

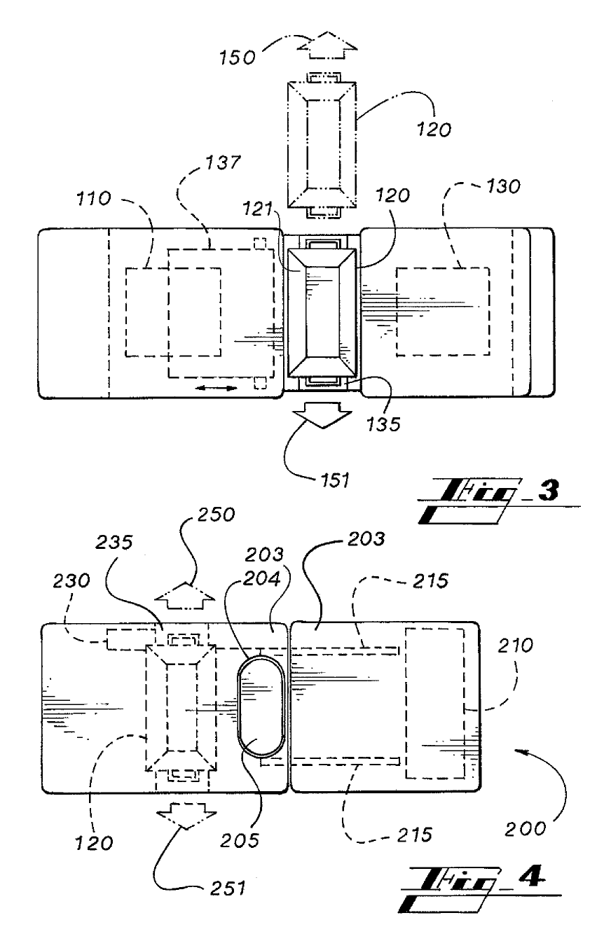

Drive means 110 preferably comprises a mechanical drive means, such as an electric motor coupled to belts, pulleys, sheaves, cables, chains, gears, screws, or other mechanical means for converting an output of the motor to the desired movement of at least head section 103a and/or foot section 130b of hospital bed 100. Alternatively, however, drive means 110 may comprise any other suitable means for selectively moving head section 103a and/or foot section 103b relative to one another, such as pneumatic, hydraulic, magnetic, or other drive means. Preferably, drive means 110 is at least operable to slide foot section 103b in the direction of arrow 115 to create gap G (as shown in FIGS. 2 and 3).

Hospital bed 100 preferably further includes bedpan 120 disposed in a first storage position beneath mattress 103 and generally centrally between sides of hospital bed 100, preferably proximate a location where top section 103a abuts foot section 103b. Bedpan 120 is preferably disposed on, and supported by, support means of carriage means 130, such as tray 135, and is preferably covered by lid 137. Carriage means 130 is preferably operable to selectively move bedpan 120 between the first storage position and a second use position (as best seen with reference to FIG. 2), such as by selectively raising and lowering tray 135 to position bedpan 120 at least partially within gap G between foot section 103b and head section 13a of mattress 103. Preferably, when in the second use position, bedpan 120 does not interfere with the patient's desired body position, thereby overcoming the problem of discomfort associated with using bedpans according to conventional techniques.

Thus, by positioning bedpan 120 within gap G during use, a patient may be comfortably supported entirely by mattress 103, and need not rest on, or even come into contact with, bedpan 120, thereby avoiding discomfort to the patient. Such an arrangement is especially beneficial when the patient needs to use bedpan 120 a second time before bedpan 120 has been changed or cleaned. Since the patient preferably does not come into contact with bedpan 120 at any time during use or storage thereof, the transmission of germs, bacteria, or other contaminants carried on the bedpan to the patient is reduced.

Preferably, carriage means 130 is automatically operated to move bedpan 120 between the first storage position and the second use position when drive means 110 is operated to slide foot section 103b of mattress 103 relative to head section 103a to create gap G. Furthermore, lid 137 is preferably automatically removed from bedpan 120 when carriage means 130 moves bedpan 120 from the first storage position to the second use position, such as by maintaining lid 137 in a fixed position relative to hospital bed 100. Similarly, lid 137 is preferably automatically replaced on bedpan 120 when carriage means 130 returns bedpan 120 to the first storage position. Thus, when bedpan 120 is in the first storage position, biological waste materials contained therein are preferably sealed by lid 137 to prevent spillage of any such waste material and to prevent or reduce the escape of any waste odor from bedpan 120.

In user a patient or other individual lying in hospital bed 100 may selectively operate remote control device 113, such as by pushing one or more buttons thereon, when the patient needs to relieve himself. Preferably, pushing a single button on remote control device 113 is sufficient to both actuate drive means 110 to slide foot portion 103b of mattress 103 in the direction of arrow 115, thereby creating gap G, and to actuate carriage means 130 to remove lid 137 from bedpan 120 and to move bedpan 120 from the first storage position to the second use position, such as by raising bedpan 120 at least partially into gap G where it may comfortably be used by the patient. When the bedpan is no longer needed, the patient may preferably selectively operate remote control device 113, such as by again pushing one or more buttons, to both return foot section 103b of mattress 103 to a position abutting, or at least proximate, head section 103a, and to return bedpan 120 to the first storage position, with lid 137 sealingly disposed thereon.

At some later time, bedpan 120 may preferably be removed from tray 135, such as by a nurse or other assistant, for cleaning thereof, or for replacement with a second clean bedpan. Bedpan 120 is preferably accessible from either side of hospital bed 100, and removal of bedpan 120 is preferably accomplished by pulling bedpan 120 to the side of hospital bed 100 in the direction of either of arrows 150 or 151. Preferably, pulling bedpan 120 in the direction of arrow 150 or arrow 151 also removes lid 137 so that the nurse or other assistant can visually inspect the contents of bedpan 120, and can remove bedpan 120 if it needs to be cleaned or replaced, or can return bedpan 120 if it is unused. Alternatively, bedpan 120 may be removed automatically, such as by activating remote control device 113, causing bedpan 120 to be moved on tray 135 by carriage means 130 in the direction of arrow 150 or arrow 151. Preferably, bedpan 120 includes a disposable and/or flushable liner 121 in order to facilitate quick cleaning of bedpan 120, such that bedpan 120 may preferably be cleaned and replaced on carriage means for subsequent use.

As will be understood by one skilled in the art, gap G may alternatively be created by relative movement between head section 103a and foot section 103b other than the sliding of foot section 103b, as described above. For example, head section 103a may be slid in the direction of arrow 116, or lower portion 104 of head section 103a may be slid in the direction of arrow 116 while upper portion 105 of head section 103a is raised in the direction of arrow 117. When gap G is formed by such alternative movement of head section 103a, an overall length of hospital bed 100 is preferably not altered, such that even if hospital bed 100 includes a fixed headboard and/or footboard, or even if hospital bed 100 is disposed proximate walls or furniture that limit the length thereof, the movement of head section 103a, and thus the creation of gap G, is not impeded.

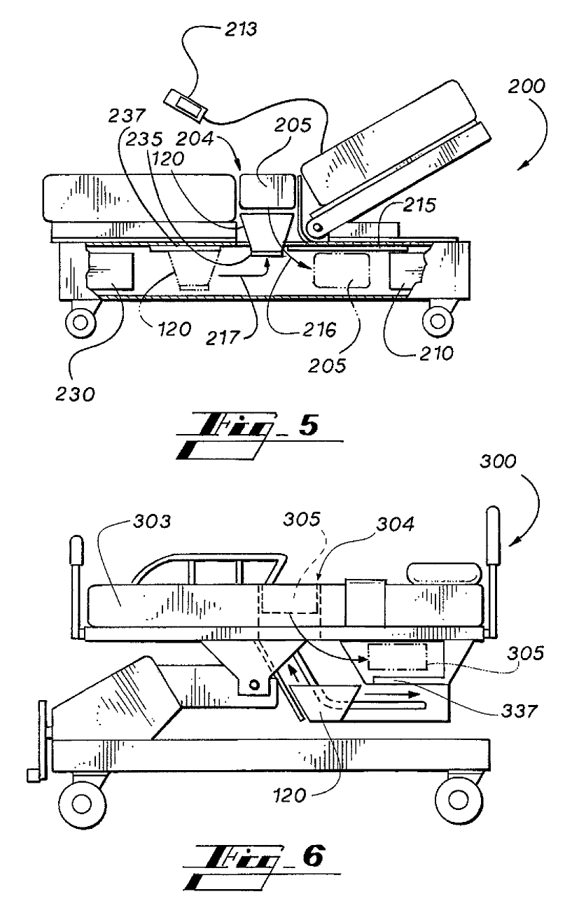

According to the alternative embodiment of FIGS. 4 and 5, hospital bed 200 preferably includes mattress 203 defining a central aperture 204 formed therethrough. As will be understood by one skilled in the art, central aperture 204 provides access to bedpan 120 disposed thereunder without movement between a head section and a foot section of mattress 203. Instead plug member 205 is preferably removably disposed in central aperture 204 to provide selective access to bedpan 120.

Such selective access is preferably enabled by drive means 210 operably connected to plug member 205 configured to selectively move plug member 205 downwardly out of central aperture 204 and laterally away from central aperture 204, such as in the direction of arrow 216; thereby, allowing bedpan 120 to be moved into the second position, such as in the direction of arrow 217. Drive means 210 is preferably controlled by a patient or other individual via remote control 213, such as by pushing a button. Preferably, plug member 205 travels on a pair of tracks 215 that guide the motion of plug member 205 as it is moved in and out of central aperture 214.

Bedpan 120 is preferably selectively moved between a first storage position disposed below mattress 103 to a second use position disposed within central aperture 204 by carriage means 230. Carriage means 230 is preferably similarly controlled via remote control 213 or by other suitable control means accessible by a patient or other individual disposed in hospital bed 200. Carriage means 230 preferably further comprises support means, such as tray 235, on which bedpan 120 is preferably removably disposed, for supporting bedpan 120 at least during storage, use, and movement thereof. Carriage means 230 preferably further comprises lid 237 for sealing bedpan 120 against spillage of waste contained therein or escape of unwanted odors when bedpan 120 is disposed in the first storage position. Preferably, as carriage means 230 moves bedpan 120 into the second use position in central aperture 204, carriage means 230 also removes lid 237 from bedpan 120, such as by maintaining lid 237 in a fixed position while bedpan 120 is moved. Bedpan 120 is preferably similarly accessible from a side of hospital bed 200 such that a nurse or other assistant may retrieve bedpan 120 periodically for cleaning or replacement, such as by pulling bedpan 120 in the direction of either of arrows 250 and 251.

Now referring to FIG. 6, Alternative hospital bed 300 is shown including automated bedpan 120 of the present invention. Hospital bed 300 preferably includes removable mattress section 305 that is selectively operable to create opening 304 in mattress 303. Bedpan 120 is preferably selectively operable to move from a first storage position in sealing engagement beneath lid 337 to a second use position within opening 304.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. An automated bedpan system comprising:
a bed comprising a first bed section movably connected to a second bed section;
drive means operable to selectively separate said first bed section and said second bed section to create a gap therebetween; and
a bedpan removably operable with carriage means for moving said bedpan between a first storage position and a second use position,
wherein said bedpan is disposed proximate said gap in said second use position.

2. The automated bedpan system of claim 1, further comprising a lid operable to selectively seal said bedpan.

3. The system of claim 1, wherein said bed comprises a dimension selected from the group consisting of a length dimension and a width dimension, and wherein creation of said gap does not increase said dimension.

4. The system of claim 1, wherein said bed comprises a dimension selected from the group consisting of a width dimension and a length dimension, and wherein creation of said gap increases said dimension.

5. The system of claim 1, wherein said bedpan is removable from either of two opposing sides of said bed.

6. The system of claim 1, further comprising a disposable liner operable to line said bedpan.

7. The system of claim i, wherein said first bed section comprises a foot section of said bed and wherein said second bed section comprises a head section of said bed.

8. The system of claim 1, wherein said first bed section comprises a mattress having a cutout and wherein said second bed portion comprises a plug complimentary to said cutout.

9. The system of claim 1, wherein said drive means and said carriage means are operable to create said gap and to dispose said bedpan in said second use position automatically in response to a control signal generated by a user.

10. A method of using a bedpan system comprising the steps of:
creating a gap between a first bed section and a second bed section;
disposing a bedpan in a use position within said gap;
disposing waste material in said bedpan;
moving said bedpan in a storage position; and
closing said gap.

11. The method of claim 10, further comprising the step of emptying said bedpan.

12. The method of claim 11, wherein said step of emptying said bedpan comprises removing a disposable liner from said bedpan, said disposable liner containing waste material.

13. The method of claim 12, wherein said step of emptying said bedpan comprises removing said bedpan, cleaning said bedpan, and replacing said bedpan.

14. The method of claim 10, wherein said step of moving said bedpan into a storage position comprises sealing said bedpan to prevent spillage of waste material and to reduce the escape of odor.

15. The method of claim 10, wherein said steps of creating a gap, disposing a bedpan in a use position, disposing waste material in said bedpan, moving said bedpan in a storage position, and closing said gap are performed by an individual disposed on at least one of said first bed section and said second bed section.

16. The method of claim 11, wherein said steps of creating a gap, disposing a bedpan in a use position, disposing waste material in said bedpan, moving said bedpan in a storage position, and closing said gap are performed by a first individual disposed on at least one of said first bed section and said second bed section, and wherein said step of emptying is performed by a second individual.

17. An automated bedpan system comprising:
a bedpan;
at least one motor; and
a control device operable to control said at least one motor, said at least one motor operable with a first bed section and a second bed section and operable with a bedpan,
wherein said at least one motor is operable to selectively create a gap between said first bed section and said second bed section and to dispose said bedpan within said gap for use by an individual disposed on at least one of said first bed section and said second bed section.

18. The automated bedpan system of claim 17, wherein said bedpan comprises a lid and a liner.

19. The automated bedpan system of claim 18, wherein said lid is automatically disengaged from said bedpan when said bedpan is disposed with said gap, and wherein said lid is automatically sealingly engaged with said bedpan when said bedpan is disposed in a storage position.

20. The automated bedpan system of claim 17, wherein said control device comprises at least one button operable by the individual to cause said motor to create said gap and to dispose said bedpan within said gap.
